(19) United States
(12) Patent Application Publication
(10) Pub. No.: US 2010/0016141 A1
(43) Pub. Date: Jan. 21, 2010

(54) APPARATUS AND METHOD FOR DYEING GLASS

(75) Inventors: Markku Rajala, Vantaa (FI); Jussi Wright, Lohja As (FI); Joe Pimenoff, Helsinki (FI); Kai Asikkala, Helsinki (FI); Jari Sinkko, Lahela (FI)

Correspondence Address: OLIFF & BERRIDGE, PLC, P.O. BOX 320850, ALEXANDRIA, VA, 22320-4850, US

(73) Assignee: BENEQ OY, Vantaa (FI)

(21) Appl. No.: 12/443,227

(22) PCT Filed: Oct. 22, 2007
(86) PCT No.: PCT/FI2007/050567

§ 371 Date: Mar. 27, 2009

(30) Foreign Application Priority Data
Oct. 20, 2006 (FI) 20060924

(51) Int. Cl. C03C 4/06; C03C 23/00; C03C 21/00

(52) U.S. Cl. 501/13; 65/181; 65/30.11

(57) ABSTRACT

The present invention relates to an apparatus and a method for dyeing glass and, more particularly, an apparatus and a method, by which both surfaces of hot sheet-like glass may be dyed simultaneously and/or the surface containing tin residues of the sheet glass may be dyed to have a different colour than the surface without tin residues. The apparatus of the invention may be used for dyeing both sheet glass and utility glass, such as glass beakers.

### FIELD OF THE INVENTION

The present invention relates to a method of the preamble of claim 1 for dyeing glass and a method of the preamble of claim 10 and, more particularly, an apparatus and a method, with which both surfaces of hot, sheet-like glass may be dyed simultaneously and/or a sheet glass surface containing tin residues may be dyed with a different colour as a surface without tin residues.

In this context, dyeing refers to doping of glass in such a manner that the transmission or reflection spectrum of the glass changes in the visible light range (about 400 to 700 nm) and/or the ultraviolet light range (200 to 400 nm) and/or the near-infrared light range (700 to 2000 nm) and/or the infrared light range (2 μm to 50 μm). According to the invention, glass is dyed in such a manner that material comprising at least a glass-dyeing compound, such as a transition metal oxide, is applied in the nano-scale to the glass surface having the temperature of at least 500° C. The material dissolves and/or diffuses in the glass surface, doping it in such a manner that a colour characteristic of the dyeing compound is provided in the glass. Essential to the invention is that the same or a different glass-dyeing compound is applied to the opposite glass surfaces, in which case the colour of the glass is the colour that is produced as a combined effect of these different surfaces. Essential to an embodiment of the invention is that tin on one surface of the sheet glass influences the shade of colour to be produced. Such a tin-doped glass surface is created when sheet glass is manufactured with a float method.

In order to dye glass efficiently, i.e. in a sufficiently short time at a temperature of 500 to 800° C., the material used in the dying should be in the nano-scale. There are two reasons for this. Firstly, the rate of diffusion of particles in a medium depends substantially on the size of the particle, and typically the rate of diffusion for particles having the size of 10 nm is three times as high as for particles having the size of 1 micrometre. Secondly, when the material is in the nano-scale, the surface area and surface energy required for dyeing reactions will increase.

The apparatus according to the invention may be used for dyeing both sheet glass and utility glass, such as glass beakers.

### DESCRIPTION OF THE PRIOR ART

Perception of visible colour is based on three factors: light (the source of colour), object (how it responds to the colour) and eye. Glass responds to colour in two ways: through reflection and transmission. The glass colour usually refers to its transmission curves, and the colour is determined by measuring glass transmission as a function of wavelength τ(λ) and then calculating the colour coordinates X, Y and Z with formulas

$$\begin{matrix}X = k {\sum }_{λ}^{ } τ ( λ ) S ( λ ) \overline{x} ( λ ) Δ λ & ( 1 ) \\ Y = k {\sum }_{λ}^{ } τ ( λ ) S ( λ ) \overline{y} ( λ ) Δ λ & ( 2 ) \\ Z = k {\sum }_{λ}^{ } τ ( λ ) S ( λ ) \overline{z} ( λ ) Δ λ & ( 3 )\end{matrix}$$

where X, Y and Z are the tristimulus values of the colour, x̅(λ), y̅(λ), z̅(λ) are the colour matching functions of a standard observer (determined by CIE, i.e. Commission Internationale de l'clairage), S(λ) is the relative power distribution of the light source as a function of wavelength, τ(λ) is the light transmission of glass as a function of wavelength and Δλ is the wavelength interval used in the calculation, typically 5 nm. The matching constant k is calculated with the formula

$$k = \frac{100}{{\sum }_{λ} S ( λ ) y ( \overline{λ )} Δ λ} \qquad ( 4 )$$

By using X,Y and Z coordinates, L*a*b* coordinates generally used in colour presentations may further be calculated with formulas

$$\begin{matrix}{L}^{*} = 116 ( \frac{Y}{{Y}_{n}} ) - 16 & ( 5 ) \\ {a}^{*} = 500 [ {( \frac{X}{{X}_{n}} )}^{1 / 3} - {( \frac{Y}{{Y}_{n}} )}^{1 / 3} ] & ( 6 ) \\ {a}^{*} = 500 [ {( \frac{X}{{X}_{n}} )}^{1 / 3} - {( \frac{Y}{{Y}_{n}} )}^{1 / 3} ] & ( 7 )\end{matrix}$$

where Xₙ, Yₙ, Zₙ represent the values for a specific white object.

The colour difference between two different objects is calculated with the formula

ΔE=\sqrt{(ΔL*)²+(Δa*)²+(Δb*)²} (8)

(Source: University of Joensuu, Department of Physics, Väisälä Laboratory, Dissertation 30, 2002, ISBN 952-458-077-2, J. Hiltunen, “Accurate Color Measurement”, particularly pages 4 to 20.)

To provide two glasses with the same colour, ΔE should be below a certain limit value. If ΔE is smaller than 2, the human eye does no longer detect the colour difference.

The float glass process developed by Pilkington in 1952 is nowadays a standard method of sheet glass manufacture throughout the world. With the process, sheet glass having the thickness of 0.6 to 25 mm may be manufactured. In the process, a raw material mixture with an accurate composition is first melted in a furnace. The molten glass of about 1000° C. flows as a continuous ribbon out of the furnace into a tin bath with an atmosphere consisting of nitrogen and hydrogen. The glass is spread onto the molten tin as a smooth surface. The glass thickness is determined by adjusting the drawing speed, at which the hardening glass ribbon is passed forwards from the tin bath. After a controlled cooling, the glass is practically equally smooth on both sides.

From the tin bath, small amounts of metallic tin adhere to the lower surface of the glass ribbon. Tin exists in the glass with both valence Sn^{+II} (typically SnO) and valence Sn^{+IV} (SnO₂). Sn^{+II} may reduce the other metallic compound in the glass. The tin diffuses in the glass typically into a depth of 10 micrometres (Journal of Physics D: Applied Physics, 27, 8, 14 Aug. 1994, Yang, B. et al, “Cathodoluminescence and depth profiles of tin in float glass”, pages 1757 to 1762), and its concentration in this layer is approximately 1 mg/cm².

On a large scale, glass dyeing means the changing of the interaction between glass and electromagnetic radiation directed to it so that the transmission of radiation through the glass, its reflection from the glass surface, absorption into the glass or scattering from the glass components changes. The most important wavelength ranges are ultraviolet range (prevention of the sun's ultraviolet radiation passing through the glass, for example), visible light range (changing of the glass colour visible to the human eye), near-infrared range (changing of the transmission of the sun's infrared radiation or the glass material used in active optical fibres) and the actual infrared range (changing of the transmission of thermal radiation). Thus, the dyeing of glass may change the transmission spectrum of glass at least in some parts of the wavelength range of 250 to 3000 nm.

Glass is dyed typically in two alternative ways: body-tinted glass (coloured glass) is manufactured by adding to the molten glass substances, which provide the glass with a characteristic colour. Surface-coloured glass is manufactured by bringing the glass into contact with a compound of a colouring agent, in which case the colouring agent is transferred to the glass by an ion exchange (stained glass). The glass may also be coated with coloured glaze or enamel layers to achieve a coloured surface.

Body-tinted glass is manufactured by adding to the molten glass or raw materials of the molten glass compounds of colouring metals, such as iron, copper, chromium, cobalt, nickel, manganese, vanadium, silver, gold, rare earth metals or the like. Such a component causes an absorption or scattering of a certain wavelength range in the glass, thus providing the glass with a characteristic colour. Adding a colouring agent to the molten glass or raw materials causes, however, that it is very expensive and time-consuming to change the colour. Consequently, it is costly to manufacture small batches of coloured glass in particular.

The colour, light transmission and ultraviolet light transmission of glass depend on the glass components in a complex way. The behaviour and properties of the components in the molten glass depend on the oxidation/reduction degree (valence) thereof and whether the metal in the glass structure is set to be a former or reformer of the structure. Other raw materials of the glass, such as other colouring metals, have an essential influence on the valence.

Formulas 1 to 3 show that when the transmission spectrum τ(λ) of the glass changes, the colour of the glass is not the same anymore. The shape of the transmission spectrum changes whenever, instead of one colouring metal, a plurality of colouring metals are mixed into the molten glass, whereupon τ(λ) changes in a non-predictable way.

Thus, a typical problem with the prior art dyeing of glass is that it is usually difficult if not impossible to mathematically determine the colour when the glass is dyed with at least two metal ions, and that is why the composition of glass with a certain colour is found out experimentally. Such a coloured soda glass is described in a PCT application PCT/EP02/13733, for instance.

To dye the glass grey, nickel oxide is often used. When glass is manufactured with a float process, a molten glass web travels on top of a tin bath. To prevent oxidation of the tin bath, the gas atmosphere above the tin bath is reducing. However, this results in the reduction of nickel on the glass surface, and metallic nickel is produced on the glass surface, providing the glass surface with a haze that impairs the glass quality. To eliminate this problem, nickel-free compositions of grey glass have been developed, one of which is presented in U.S. Pat. No. 4,339,541, for example. The method is thus still based on dyeing the molten glass entirely.

U.S. Pat. No. 2,414,413 discloses a method of adding to the molten glass reducing agents, such as silicon or mixtures containing silicon, which prevent evaporation of selenium (Se) from the molten glass.

U.S. Pat. No. 4,748,054 discloses a method of dyeing glass with layers of pigment. In this case, the glass is sand-blasted and different enamel layers are pressed thereto and then burnt to the glass surface. However, the chemical or mechanical wear resistance of such a glass is poor.

Surface colouring of glass is a technology, which is hundreds of years old and is based on an ion exchange on a glass surface. The method is used widely when glass is coloured red or yellow by using silver or copper. Typically, copper salt or silver salt is mixed into a suitable medium and water is added to the mixture, whereby sludge with a suitable viscosity is achieved. The sludge is then applied onto the surface of the glass to be dyed and the glass object is typically heated to a temperature of a few hundred degrees, at which the ion exchange takes place and the glass is dyed. After this, the dry sludge is removed from the glass surface by washing and brushing. The method is not suitable as such for industrial production.

U.S. Pat. No. 1,977,625 discloses an altered surface colouring of glass based on spraying a solution onto a surface of hot glass (about 600° C.), the solution comprising salt of a colouring metal (silver nitrate in the example of the patent) and a reducing agent, such as sugar, glycerine or Arabic gum. The solution also comprises a flux, due to which the melting temperature of the glass surface decreases and colouring ions penetrate into the glass. Such a flux may be a compound of lead and boron, for instance. The use of a flux, however, usually weakens the chemical and/or mechanical resistance of the glass surface and the method is thus not useful on a large scale.

U.S. Pat. No. 2,075,446 discloses a method of manufacturing surface-coloured glass, the method comprising immersing a glass object in a molten metal salt for a certain time, from which, as a result of an ion exchange, silver and copper ions are transferred to the glass object, thereby producing a coloured surface. Because of the immersion stage, the method is not generally useful in glass production, since it cannot be used in the manufacture-of sheet glass in the float line, for example.

U.S. Pat. No. 2,428,600 discloses a method of manufacturing surface-coloured glass, the method comprising bringing glass containing alkali metals into contact with a volatile copper halide, whereupon ions of the alkali metal on the surface layer of the glass are exchanged for copper ions and the glass is then brought into contact with hydrogen gas, whereby the copper reduction caused by hydrogen produces the colour for the glass surface. An inverse manufacturing method of the same thing—the glass is first treated with hydrogen and then brought into contact with copper halide steam—is presented in U.S. Pat. No. 2,498,003.

U.S. Pat. No. 2,662,035 discloses a plurality of combinations consisting of copper, silver and zinc, which provide the glass surface with different colours. As a dyeing method, the patent applies the covering of the glass surface with a dispersion, from which metal ions are exchanged into the surface layer of the glass.

U.S. Pat. No. 3,967,040 discloses a method for surface-colouring glass, in which method a reducing metal (preferably tin) adhered to the glass surface during the float process or in some other way acts as a reducing agent so that when the glass is surface-coloured with a silver-containing salt, a characteristic colour is produced. The salt of the colouring metal in contact with the glass acts as a colouring agent.

U.S. Pat. No. 5,837,025 discloses a method of dyeing glass with nano-sized glass particles. According to the method, grasslike, coloured glass particles are produced and directed to the surface of the glass to be dyed and sintered into transparent glass at a temperature below 900° C. The method differs from that of the present invention in that in the present invention, the particles diffuse into the glass and do not form a separate coating on the glass surface.

Finnish Patent FI98832, Method and apparatus for spraying material, discloses a method, which can be used in doping glass. In this method, a material to be sprayed is passed into a flame in the liquid form and is converted into the droplet form with the aid of a gas, essentially in the region of the flame. This gives a rapid, advantageous and single-stage method for producing very small particles of the order of magnitude of nanometres.

Finnish Patent FI114548, Method for dyeing a material, discloses a method for dyeing glass with colloidal particles. In the method according to the patent, a flame spraying method is used for providing the material to be dyed with colloidal particles. In the method, other components, such as liquid or gaseous glass-forming material may be added, if desired, to the flame, by which it is possible to form colloidal particles having the right size in the material.

One of the most important properties of window glass is its transparency. Irregularities may occur on the structure and surface of the glass, causing light refraction and scattering. Haziness, i.e. the amount of scattered, visible light that has changed its direction, is described with a haze percentage scale. In practice, haziness refers to deterioration of optical properties of transparent glass: the view through the glass becomes hazy and fuzzy. Depending on the purpose of use, the haze value of glass should not exceed a certain limit value. For instance, the haze value of colourless window glass should not exceed about 0.2%. A haze value below one percent is difficult to perceive with the eye.

Phase separations, crystal seeds, crystals, colloidal particles and other irregularities of a glass structure on the surface of and inside the glass, which change the refractive index of the glass, act as scattering centres. The size of a scattering centre affects the quality of scattering. When the diameter d of the scattering centre is clearly shorter than the wavelength λ of incident light, i.e. d<<λ, the light is scattered at all angles. The magnitude of scattering depends on the measuring angle. Scattering is more intense when the wavelength of light decreases, i.e. blue light is scattered most intensely in the range of visible light. When the diameter of the scattering centre is in the region of the wavelength of visible light (400 to 800 nm), i.e. d˜λ, the light is mainly scattered forwards.

When glass is dyed with a method mentioned in Patent FI98832, for example, and the purpose is to achieve dark colours, which means a high concentration of a colouring agent on the glass surface, the problem arises that a lot of particles or other irregularities of the glass structure are also formed on the glass surface, causing an increase in the haze value of the glass.

The prior art has not disclosed a method, in which the dyeing of sheet glass manufactured with the float technology utilizes the different reducing ability of different sides of the glass in order to produce a coloured surface in the glass manufacture or processing in such a manner that the dyeing may be carried out with the same production rate as glass manufacture with the flot process or glass processing, such as glass tempering. Nor has the prior art disclosed a method, in which both surfaces of sheet glass are dyed separately, by which either a darker colour or surfaces of different colours are produced so that the colouring metal ions do not have an effect on each other's valence. Also, the prior art has not disclosed a method, by which glass could be surface-coloured dark without increasing its haze value disadvantageously.

There is clearly a need for a method and an apparatus, by which sheet glass may be dyed on both sides of the glass during its production or processing, and in connection of which dyeing the interaction of colouring metal ions is avoided, or in which connection tin adhered to the surface of the sheet glass in a float process may preferably be utilized, and which method does not have a disadvantageous effect on the haze value of the glass.

### SUMMARY OF THE INVENTION

It is an object of the present invention to provide an apparatus and a method, which fulfill the above-mentioned requirements.

This is achieved with an apparatus according to the characterizing part of claim 1 and a method according to the characterizing part of claim 10, wherein nanoparticles are directed to both sides of a hot glass ribbon or sheet glass, the particles comprising at least one compound of a metal providing the glass with its characteristic colour. The temperature of the glass at the coating point is 500 to 800° C. The nanoparticles diffuse and dissolve in the glass surface, typically into a depth of below 100 micrometres, and provide glass surface, typically into a depth of below 100 micrometres, and provide the glass surface with a colour characteristic of that metal. Since the penetration depth is considerably smaller than the thickness of the float glass, the diffused and dissolved nanoparticles directed to the opposite surfaces do not interact with one another, wherefore the ions of the colouring metals do not have an influence on each other's oxidation/reduction degree or the colour to be produced. The metal ions of the nanoparticles, which dissolve in the tin side of the float glass, interact with the tin on the glass surface, whereby the tin typically reduces the metal compound, possibly even to metal, and the produced colour is an absorption colour achieved with the reduced metal compound or a scattering colour achieved with the metal or a combination thereof. However, in cases where the metal ion only has one oxidation degree, the tin on the glass surface is not significant to the colour to be produced, and the material dyeing the glass may be directed to either one of the glass surfaces. An example of such a case is a combined use of cobalt oxide and silver in dyeing.

The apparatus of the invention is typically integrated into an apparatus for manufacturing float glass or a glass processing apparatus, such as a glass tempering or bending apparatus.

Preferably the apparatuses for directing nanoparticles are set against a sheet glass surface in such a manner that directing geometries are mirror images of one another, in which case an effect of the coating process other than the colouring effect on the opposite surfaces of the glass is the same and no optical errors occur in the glass.

The concentration of the nanoparticles on the glass surface is preferably such that the particles do not increase the haze value of the glass but the glass may be dyed dark, since the glass is dyed on the opposite surfaces.

### SHORT DESCRIPTION OF THE DRAWINGS

FIG. 1 illustrates distribution of colouring metal ions in body-tinted and surface-coloured glass, and coloured glass produced with an apparatus and a method of the invention.

FIG. 2 shows an embodiment of a glass-dyeing apparatus of the invention.

FIG. 3 shows a transmission spectrum of glass dyed green with the method of the invention, the method comprising directing nanoparticles containing cobalt oxide to one surface of the glass and nanoparticles containing silver to the other surface.

FIG. 4 shows a transmission spectrum of the glass dyed green with the method of the invention, compared with a computational transmission spectrum.

The invention is described in the following in greater detail with reference to the drawings.

### DETAILED DESCRIPTION OF THE INVENTION

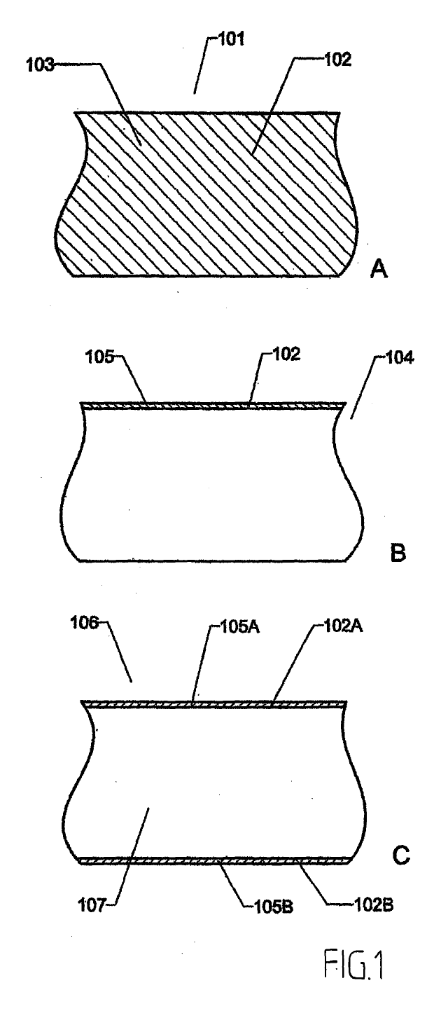

The colour of glass is based on either absorption or scattering. An absorption colour is usually caused by absorption due to a metal oxide in the glass, particularly a transition element, or a lanthanoide oxide, and a scattering colour is caused by scattering due to a noble metal particle of 10 to 40 nm in the glass. FIG. 1A shows the structure of body-tinted sheet glass 101, wherein a colouring oxide 102 is substantially evenly distributed in molten glass 103. The portion of the colouring oxide in the entire molten glass is from a few per mille to a few percent.

Dyeing the whole of molten glass is expensive, particularly because the whole of molten glass from the glass melting furnace must be changed when the colour of the glass is changed, and during the change, the glass does not have a first-class quality. A colour change thus causes high costs for a glass factory.

Glass may be surface-coloured in different ways, and the structure of surface-coloured glass is shown in FIG. 1B. In surface-coloured glass 104, a colouring oxide 102 exists in a surface 105 of the glass, typically in a depth of below 100 micrometres. In this case, the concentration of the colouring oxide 102 in the surface layer must be considerably higher than the concentration in body-tinted glass. For example, in coloured sheet glass having a thickness of 4 mm, the concentration of the colouring oxide 102 of surface-coloured glass in the coloured surface layer must be about 100 times higher than the concentration in body-tinted glass. Since the solubility of the colouring oxide 102 in a glass material is usually limited, surface-coloured glass does not usually produce as dark shades as body-tinted glass.

The structure of glass 107 dyed with the method of the invention is shown in FIG. 1C. In the method, a coloured surface 105A and 105B is created on both surfaces of the glass. Firstly, darker pieces of surface-coloured glass are provided in this way. The invention also provides the advantage that, if desired, a surface of a different colour may be provided on both surfaces 105A and 105B of the glass. Normally, producing a glass colour by combining colouring metal oxides 102A and 102B is a complex process, because metal ions interact with one another, whereby their oxidation state changes, which affects the glass colour in a manner that cannot be predicted mathematically. With the method of the invention, a coloured glass layer 102A is produced on one side of the glass 106, the transmission spectrum of which is τ₁(λ), and a coloured glass layer 102B is produced on the other side of the glass, the transmission spectrum of which is τ₂(λ). The colouring metals 102A and 102B producing the spectrum do not interact with one another. Thus, the transmission spectrum of the combination glass is t₃(λ)=τ₁(λ)τ₂(λ), on the basis of which a combination colour formed in the glass may be calculated directly by means of Formulas 1 to 8 shown above. Thus, by combining dyeing layers having known transmission spectra τᵢ(λ) and τⱼ(λ), predictable combination colours may be produced, the transmission spectrum of which is tᵢⱼ(λ)=τᵢ(λ)τⱼ(λ). Particularly, if τᵢ(λ)=τⱼ(λ), coloured glass is obtained, the colour of which is darker than that of glass which is only dyed on one side.

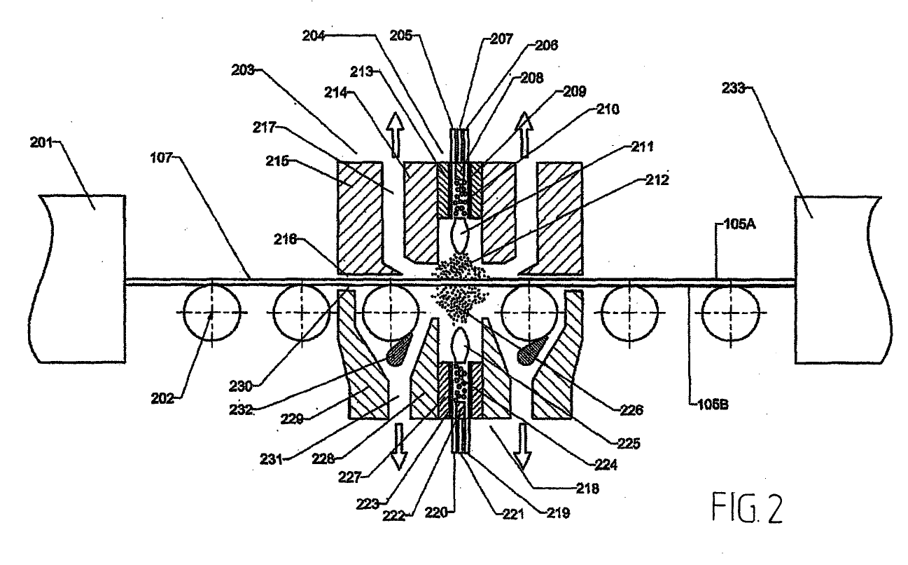

FIG. 2 shows a principle view of a glass-dyeing apparatus 203 of the invention to be used in the manufacture of float glass. Sheet glass 107 is pulled from a bath of molten metal, such as a tin bath 201, and it is conveyed on top of conveyor rolls 202. The sheet glass 107 travels on the conveyor rolls 202 to the glass-dyeing apparatus 203. An important part of the glass-dyeing apparatus 203 is an apparatus 204 for producing nanomaterials. FIG. 2 shows an apparatus 204 for producing nanomaterials based on flame synthesis. In this apparatus, a liquid raw material containing the metallic salts necessary for producing nanomaterials is supplied to a first production apparatus 204 from a channel 207. The liquid raw materials are sprayed as droplets 210 in a nozzle 208 and the droplets 210 are led to a mixing chamber 209. Also, combustion gas from a channel 205 and oxygen from a channel 206 are led to the mixing chamber 209. The gases and the liquid droplets 210 are mixed in the mixing chamber 209, after which they exit from the mixing chamber and form outside the chamber a burning mixture of gas and liquid that is lighted into a flame 211. The raw materials form nano-sized particles 212 in the flame 211, which are attached to the top surface 105A of the sheet glass 107 due to a combined effect of impaction, diffusion, thermophoresis and electrical powers. The non-attached particles and combustion gases are discharged by discharge means, which lead them to a discharge channel 217, which is formed by walls 214 and 215. The discharge channel is thermally insulated from the first apparatus 204 for producing nanomaterials by means of an insulator 213. Air is sucked through a gap 216 from outside the production apparatus 204 into the discharge channel 217, thus preventing the nanoparticles 212 from passing out of the first production apparatus 204, except along the discharge channel 217 in a controlled manner. Accordingly, the liquid raw material containing the metallic salts necessary for producing nanomaterials is supplied to a second production apparatus 218 from a channel 221. The liquid raw materials are sprayed as droplets 224 in a nozzle 222 and the droplets 224 are led to a mixing chamber 223. Also, combustion gas from a channel 219 and oxygen from a channel 220 are led to the mixing chamber 223. The gases and the liquid droplets 224 are mixed in the mixing chamber 223, after which they exit from the mixing chamber and form outside the chamber a burning mixture of gas and liquid that is lighted into a flame 225. The raw materials form nanosized particles 226 in the flame 225, which are attached to the lower surface of the sheet glass 107 due to a combined effect of impaction, diffusion, thermophoresis and electrical powers. The non-attached particles and combustion gases are discharged by discharge means, which lead them into a discharge channel 231, which is formed by walls 228 and 229. The discharge channel is thermally insulated from the second apparatus 218 for producing nanomaterials by means of an insulator 227. Air is sucked through a gap 230 from outside the second production apparatus 218 into the discharge channel 231, thus preventing the nanoparticles 226 from passing out of the production apparatus 218, except along the discharge channel 231 in a controlled manner. Nanoparticles which are possibly attached to the surface of the conveyor rolls 202 under the sheet glass 107 are removed by a scraper 232. As a result, the upper surface 105A and the lower surface 105B of the sheet glass 107 are dyed before the sheet glass is passed to a cooling furnace 233.

According to the present invention, a particle material 212, 226 is led preferably by the first and second production means 204, 218 onto the surface of the sheet glass substantially perpendicularly. In addition, the composition of the particle materials produced with the production means 204, 218 may be the same or different, and thus the same or a different particle material/materials may be led to the first and second surfaces 105A, 105B of the sheet glass, in which case the sheet glass may also be dyed on the first sheet glass, in which case the sheet glass may also be dyed on the first and second sides in the same manner or in a different manner. Thus, the opposite surfaces 105A, 105B of the sheet glass may be dyed separately according to the present invention, whereby the glass may be dyed darker than in the prior art and/or the opposite surfaces may be dyed with different colours, since the metal ions or particle materials directed to the opposite surfaces 105A and 105B do not affect one another.

The method according to the present invention may be combined with a normal production and/or processing, such as a float process, a casting process or tempering. Likewise, the method of the invention may be mounted in connection with equipment for producing sheet glass or processing equipment, or integrated thereto.

### Examples

The invention will be described in the following by means of an example.

### Example 1

### Dyeing Glass Green

The raw material for silver particles was prepared by dissolving 25 g of silver nitrate AgNO₃ in 100 millilitres of methanol. This solution was supplied into the channel 207 of the glass-dyeing apparatus 203 shown in FIG. 2 at a rate of 10 ml/min. The liquid was formed into droplets by supplying hydrogen gas to the channel 205 with a volume flow of 20 litres per minute. Oxygen gas was supplied into the channel 206 with a volume flow of 10 litres per minute. The raw materials reacted in the flame 211 and formed Ag nanoparticles 212, the average diameter of which was about 30 nm. The particles were partly agglomerated as particle chains. The particles were led to the upper surface of the sheet-like glass 107, whereby they formed a glass layer 105A dyed yellow. The raw material for cobalt oxide particles was prepared by dissolving 30g of hexahydrate of cobalt nitrate Co(NO₃)₂6H₂O in 100 millilitres of methanol. This solution was supplied into the channel 2221 of the glass-dyeing apparatus 203 shown in FIG. 2 at a rate of 10 ml/min. The liquid was formed into droplets by supplying hydrogen gas into the channel 219 with a volume flow of 20 litres per minute. Oxygen gas was supplied into the channel 220 with a volume flow of 10 litres per minute. The raw materials reacted in the flame 225 and formed CoO nanoparticles 226, the average diameter of which was about 30 nm. The particles were partly agglomerated as particle chains. The particles were led to the lower surface of the sheet-like glass 107, whereby they formed a glass layer 105B dyed blue.

After the coating, tensions in the glass 107 were removed by keeping the glass at a temperature of 500° C. for 15 minutes, after which the glass was cooled to room temperature over a period of 3 hours.

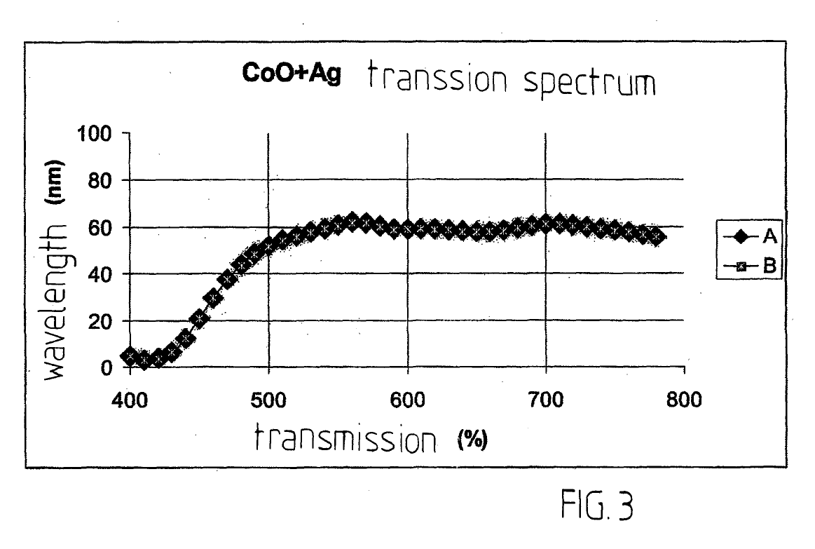

After the cooling it was detected that the transmission colour of the glass was green. The transmission spectrum of the glass is shown in FIG. 3 (curve A).

Furthermore, the raw material for cobalt oxide particles was prepared by dissolving 30 g of hexahydrate of cobalt nitrate Co(NO₃)₂6H₂O in 100 millilitres of methanol. This solution was supplied into the channel 207 of the glass-dying apparatus 203 shown in FIG. 2 at a rate of 10 ml/min. The liquid was formed into droplets by supplying hydrogen gas to the channel 205 with a volume flow of 20 litres per minute. Oxygen gas was supplied into the channel 206 with a volume flow of 10 litres per minute. The raw materials reacted in the flame 211 and formed CoO nanoparticles 212, the average diameter of which was about 30 nm. The particles were partly agglomerated as particle chains. The particles were led to the top surface of the sheet-like glass 107, whereby they formed a glass layer 105A dyed blue. The raw material for silver particles was prepared by dissolving 2 5g of silver nitrate of AgNO₃ in 100 millilitres of methanol. This solution was supplied, into the channel 2221 of the glass-dyeing apparatus 203 shown in FIG. 2 at a rate of 10 ml/min. The liquid was formed into droplets by supplying hydrogen gas into the channel 219 with a volume flow of 20 litres per minute. Oxygen gas was supplied into the channel 220 with a volume flow of 10 litres per minute. The raw materials reacted in the flame 225 and formed Ag nanoparticles 226, the average diameter of which was about 30 nm. The particles were partly agglomerated as particle chains. The particles were led to the lower surface of the sheet-like glass 107, whereby they formed a glass layer 105B dyed yellow.

After the coating, tensions in the glass 107 were removed by keeping the glass at a temperature of 500° C. for 15 minutes, after which the glass was cooled to room temperature over a period of 3 hours.

After the cooling it was detected that the transmission colour of the glass was green, and the transmission spectrum of the glass was substantially the same as when the silver particles were led to the upper surface of the glass. The transmission spectrum of the glass is shown in FIG. 3 (curve B).

### Example 2

### Calculating Glass Colour

The raw material for silver particles was prepared by dissolving 25 g of silver nitrate AgNO₃ in 100 millilitres of methanol. This solution was supplied into the channel 207 of the glass-dyeing apparatus 203 shown in FIG. 2 at a rate of 10 ml/min. The liquid was formed into droplets by supplying hydrogen gas into the channel 205 with a volume flow of 20 litres per minute. Oxygen gas was supplied into the channel 206 with a volume flow of 10 litres per minute. The raw materials reacted in the flame 211 and formed Ag nanoparticles 212, the average diameter of which was about 30 nm. The particles were partly agglomerated as particle chains. The particles were led to the upper surface of the sheet-like glass 107, whereby they formed a glass layer 105A dyed yellow. After the coating, tensions in the glass 107 were removed by keeping the glass at a temperature of 500° C. for 15 minutes, after which the glass was cooled to room temperature over a period of 3 hours.

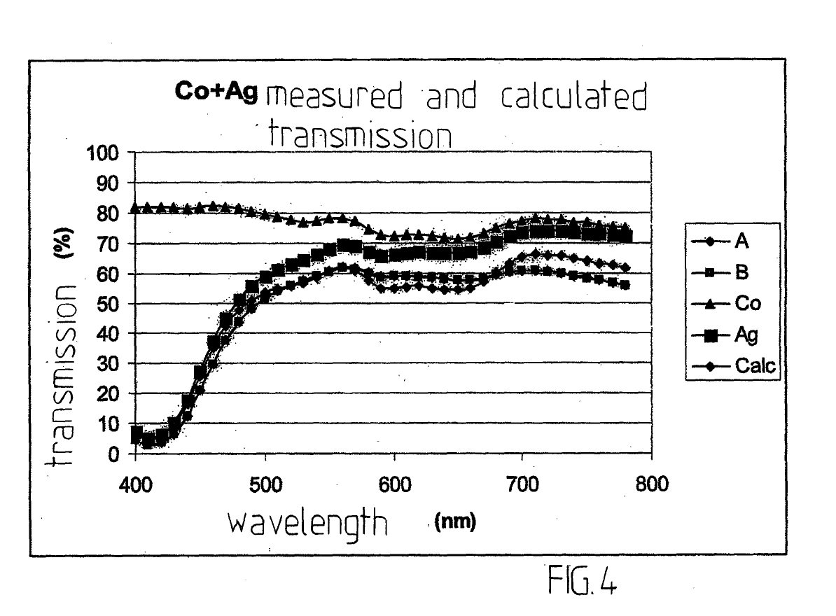

After the cooling it was detected that the transmission colour of the glass was yellow. The transmission spectrum of the glass is shown in FIG. 4 (curve Ag).

The raw material for cobalt oxide particles was prepared by dissolving 30 g of hexahydrate of cobalt nitrate Co(NO₃)₂6H₂O in 100 millilitres of methanol. This solution was supplied into the channel 2221 of the glass-dyeing apparatus 203 shown in FIG. 2 at a rate of 10 ml/min. The liquid was formed into droplets by supplying hydrogen gas into the channel 219 with a volume flow of 20 litres per minute. Oxygen gas was supplied into the channel 220 with a volume flow of 10 litres per minute. The raw materials reacted in the flame 225 and formed CoO nanoparticles 226, the average diameter of which was about 30 nm. The particles were partly agglomerated as particle chains. The particles were led to the lower surface of the sheet-like glass 107, whereby they formed a glass layer 105B dyed blue.

After the coating, tensions in the glass 107 were removed by keeping the glass at a temperature of 500° C. for 15 minutes, after which the glass was cooled to room temperature over a period of 3 hours.

After the cooling it was detected that the transmission colour of the glass was blue. The transmission spectrum of the glass is shown in FIG. 4 (curve Co).

The measured values of the previous tests were multiplied by one another and scaled by deleting the double absorption of transparent glass, as a mathematical result of which the curve Calc of FIG. 4 was obtained. This curve is substantially the same as the transmission curve of the glass dyed on two sides (curves A and B in FIG. 4, where A is covered by B). When estimated visually, it can also be stated that by setting the samples Ag and Co dyed on one side on top of one another, the colour of the group of overlapping pieces of glass is the same as the colour of the glass dyed on two sides.

### Example 3

### Effect of Amount of Supplied Dyeing Raw Material on Glass Haze Value

The raw material for cobalt oxide particles was prepared by dissolving 30 g of hexahydrate of cobalt nitrate Co(NO₃)₂6H₂O in 100 millilitres of methanol. This solution was supplied into the channel 207 of the glass-dyeing apparatus 203 shown in FIG. 2 at a rate of 10 ml/min. The liquid was formed into droplets by supplying hydrogen gas into the channel 205 with a volume flow of 20 litres per minute. Oxygen gas was supplied into the channel 206 with a volume flow of 10 litres per minute. The raw materials reacted in the flame 211 and formed CoO nanoparticles 212, the average diameter of which was about 30 nm. The particles were partly agglomerated as particle chains. The particles were led to the upper surface of the sheet-like glass 107, whereby they formed a glass layer 105A dyed blue.

In a reference case, the raw material for cobalt oxide particles was prepared by dissolving 15 g of hexahydrate of cobalt nitrate Co(NO₃)₂6H₂O in 100 millilitres of methanol. This solution was supplied into the channel 207 of the glass-dyeing apparatus 203 shown in FIG. 2 at a rate of 10 ml/min. The liquid was formed into droplets by supplying hydrogen gas to the channel 205 with a volume flow of 20 litres per minute. Oxygen gas was supplied into the channel 206 with a volume flow of 10 litres per minute. The raw materials reacted in the flame 211 and formed CoO nanoparticles 212, the average diameter of which was about 30 nm. The particles were partly agglomerated as particle chains. The particles were led to the upper surface of the planar glass 107, whereby they formed a glass layer 105A dyed blue.

The amount of the cobalt oxide produced in the first case was twice as big as in the reference case. The haze value of the glass dyed with this solution was 2%, whereas in the reference case it was 0.2%. The haze values of the glass dyed on both sides are nearly additive, and it can be stated that the haze value of the glass dyed according to the reference case on both sides would be about 0.4%, which means that the same tone value of the glass can be achieved with a considerably smaller haze value than in one-sided dyeing.

1. A method for dyeing sheet glass in connection with sheet glass production or processing, the temperature of the sheet glass being above its cooling temperature, the method comprising dyeing a surface of the sheet glass by directing a particle material with an aerodynamic diameter of below 1000 nm to the surface of the sheet glass, whereby the material further diffuses and/or dissolves in the surface layer of the glass, providing the sheet glass with a colour typical of the composition of the particle material, wherein the method comprises directing the particle material to the opposite surfaces of the sheet glass in connection with the sheet glass production or processing to separately dye the opposite surfaces of the sheet glass.

2. A method as claimed in claim 1, wherein the particle material diffusing and/or dissolving in the surface of the sheet glass changes the colour of the sheet glass in a wavelength range, which is ultraviolet radiation, radiation in the visible light range, near-infrared radiation or infra-red radiation.

3. A method as claimed in claim 1, wherein the nano-sized material diffusing and/or dissolving in the surface of the sheet glass changes the transmission spectrum of the sheet glass at least in some parts of the wavelength range of 250 to 3000 nm.

4. A method as claimed in claim 1, wherein the particle material is directed to the opposite surfaces of the sheet glass perpendicularly.

5. A method as claimed in claim 1, wherein the composition of the material to be directed to the different sides of the sheet glass is the same.

6. A method as claimed in claim 1, wherein the composition of the material to be directed to the different sides of the sheet glass is different.

7. A method as claimed in claim 1, wherein when the same particle material is used in the manufacturing process of the sheet glass, the surface that was in contact with molten metal is dyed in a different way than the glass surface, which was not in contact with the molten metal when metal compounds adhered to the sheet glass surface, which was in contact with the molten metal, affects the sheet glass surface, diffuse to the oxidation degree of the soluble particle material and thus to the colour of the glass layer doped with the material in the dyeing process.

8. A method as claimed in claim 1, wherein the method is carried out in connection with the sheet glass manufacture implemented with a float process.

9. A method as claimed in claim 1, wherein the method is carried out in connection with the sheet glass manufacture implemented with a casting process.

10. A method as claimed in claim 1, wherein the haze value of the glass coated according to the method is lower than the haze value of the glass having substantially the same colour and being coated on one side.

11. An apparatus for dyeing sheet glass in connection with sheet glass production or processing, the temperature of the sheet glass being above its cooling temperature, the apparatus comprising production means for producing a particle material with an aerodynamic diameter of below 1000 nm and for directing the particle material to a surface of the sheet glass in such a manner that at least a part of the particle material diffuses and/or dissolves in the surface layer of the sheet glass, providing the sheet glass with a colour typical of the composition of the particle material, wherein the apparatus is arranged in such a manner that particle material may be directed simultaneously to the opposite surfaces of the sheet glass in connection with the sheet glass production or processing to separately dye the opposite surfaces of the sheet glass.

12. An apparatus as claimed in claim 11, wherein the apparatus comprises first production means for producing particle material and directing it to the first surface of the sheet glass, and second production means for producing particle material and directing it to the second surface of the sheet glass.

13. An apparatus as claimed in claim 11, wherein the apparatus is provided in such a manner that the same or a different particle material may be directed to the opposite surfaces of the sheet glass.

14. An apparatus as claimed in claim 13, wherein by means of the first production means and the second production means, particle materials with the same composition or particle materials with a different composition may be produced.

15. An apparatus as claimed in claim 11, wherein the means discharge means for discharging the particle material that has not adhered to the sheet glass surface and gaseous reaction products from the surface of the hot sheet glass.

16. An apparatus as claimed in claim 11, wherein the particle materials produced by the production means are selected and provided in such a manner that the particle material diffusing and/or dissolving in the surface of the sheet glass changes the colour of the sheet glass in a wavelength range, which is ultraviolet radiation, radiation in the visible light range, near-infrared radiation or infrared radiation.

17. An apparatus as claimed in claim 11, wherein the particle materials produced by the production means are selected and provided in such a manner that the particle material diffusing and/or dissolving in the surface of the sheet glass changes the transmission spectrum of the sheet glass at least in some parts of the wavelength range of 250 to 3000 nm.

18. An apparatus as claimed in claim 11, wherein the apparatus and/or the production means are provided in such a manner that the particle material is directed to the opposite surfaces of the sheet glass perpendicularly.

19. An apparatus claimed in claim 11, wherein the apparatus is mounted/integrated in connection with equipment for manufacturing sheet glass with a float process.

20. An apparatus as claimed in claim 11, wherein the apparatus is mounted/integrated in connection with equipment for manufacturing sheet glass with a casting process.

21. Sheet glass, wherein it is dyed by the method according to claim 1.
